(19) United States
(12) Patent Application Publication
(10) Pub. No.: US 2025/0033173 A1
(43) Pub. Date: Jan. 30, 2025

(54) PNEUMATIC PULLER

(71) Applicant: BASSO INDUSTRY CORP., Taichung (TW)

(72) Inventors: Chun-Chi LAI, Taichung (TW); Chia-Wen WANG, Taichung (TW)

(73) Assignee: BASSO INDUSTRY CORP., Taichung (TW)

(21) Appl. No.: 18/783,103

(22) Filed: Jul. 24, 2024

(30) Foreign Application Priority Data
Jul. 26, 2023 (TW) 112127989

(51) Int. Cl. B25B 27/02

(52) U.S. Cl. CPC B25B 27/026

(57) ABSTRACT

A pneumatic puller includes a shell unit, a pulling member that has a fixed section and an exposed section, a piston that is fixedly connected to the fixed section, a directional valve assembly that is movably mounted to the piston, and a cylinder that is sleeved on the fixed section. The cylinder and the piston define a first chamber and a second chamber. The cylinder is movable along the fixed section between a first reverse position and a second reverse position relative to the piston when urged by pressure of a gas. The cylinder abuts against one side of the piston and the directional valve assembly releases the gas into the second chamber when the cylinder is in the first reverse position. The cylinder moves along the fixed section away from the exposed section and hits the piston when moving from the first reverse position to the second reverse position.

### CROSS-REFERENCE TO RELATED APPLICATION

This application claims priority to Taiwanese Invention Patent Application No. 112127989, filed on Jul. 26, 2023, the entire disclosure of which is incorporated by reference herein.

### FIELD

The disclosure relates to a puller, and more particularly to a pneumatic puller for pulling an object in a direction of an impact force.

### BACKGROUND

Referring to FIG. 1, a conventional pin puller 1 disclosed in Chinese Patent Publication No. CN209095459 includes a connecting rod 11, a sliding portion 12 that is capable of moving along the connecting rod 11, a nail extractor 13 that is fixedly connected to one end of the connecting rod 11, and an abutment portion 14 that is fixedly connected to another end of the connecting rod 11. Through such operation, when the nail extractor 13 engages a pin 21, and when the sliding portion 12 is moved upwardly along the connecting rod 11 by an external force and hits the abutment portion 14, the connecting rod 11 together with the nail extractor 13 is bounced upwardly by an impact force and pulls the pin 21 upwardly, thereby removing the pin 21 from a component 22.

Since the impact force mainly comes from the external force that is applied to the sliding portion 12 by an operator, in the case of a human force that is limited by physical fitness, manual operation is labor-intensive and time-consuming, and oftentimes may encounter technical problems such as the impact force being insufficient to remove the pin 21.

It is noted that, the sliding portion 12 is not limited to be manually operated, and may be driven by gas pressure. Therefore, the impact force is enhanced by the gas pressure. However, when the sliding portion 12 is subjected to the gas pressure, the sliding portion 12 may quickly reciprocate along the connecting rod 11. Therefore, during reciprocating motion of the sliding portion 12, the sliding portion 12 may easily come into contact with a person or an object in its surroundings. Hence, there is still room for improvement of the conventional pin puller 1 in terms of safety.

### SUMMARY

Therefore, an object of the disclosure is to provide a pneumatic puller that can alleviate at least one of the drawbacks of the prior art.

According to the disclosure, the pneumatic puller includes a shell unit, a pulling member, a valve unit, and a cylinder. The shell unit defines a sliding space. The pulling member is fixedly connected to the shell unit, and has a fixed section that extends in the sliding space, and an exposed section that is opposite to the fixed section. The valve unit includes a piston that is fixedly connected to the fixed section, and a directional valve assembly that is movably mounted to the piston and that is adapted for controlling a gas flow direction. The cylinder is movably disposed in the sliding space, is sleeved on the fixed section, and includes a cylinder wall that surrounds the piston and that is in airtight contact with the piston. The cylinder and the piston define a first chamber and a second chamber. The cylinder is movable along the fixed section between a first reverse position and a second reverse position relative to the piston when urged by pressure of a gas. When the cylinder is in the first reverse position, the cylinder abuts against one side of the piston, and the directional valve assembly releases the gas into the second chamber. When the cylinder is in the second reverse position, the cylinder abuts against another side of the piston, and the directional valve assembly releases the gas into the first chamber. The cylinder moves along the fixed section away from the exposed section and hits the piston when moving from the first reverse position to the second reverse position.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a front view of a conventional pin puller disclosed in Chinese Patent Publication No. CN209095459.

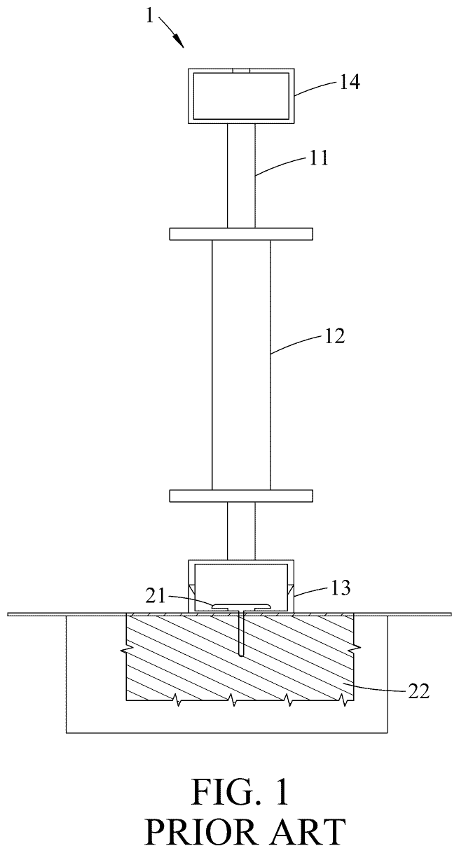

FIG. 2 is a fragmentary sectional view of a first embodiment of a pneumatic puller according to the disclosure.

FIG. 3 is a partly exploded perspective view illustrating a pulling member and a valve unit of the first embodiment.

FIG. 4 is a fragmentary sectional view taken along line IV-IV in FIG. 2.

FIG. 5 is a fragmentary sectional view illustrating that a cylinder of the first embodiment moves along a fixed section of the pulling member and that gas flows from a gas chamber of the first embodiment toward another chamber of the first embodiment.

FIG. 6 is a view similar to FIG. 5, but illustrating the cylinder hitting a piston of the valve unit.

FIG. 7 is a view similar to FIG. 5, but illustrating the gas flowing from the gas chamber toward still another chamber of the first embodiment.

FIG. 8 is a sectional view of a second embodiment of the pneumatic puller according to the disclosure.

FIG. 9 is a fragmentary sectional view of a trigger subunit and an intake valve assembly of the second embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

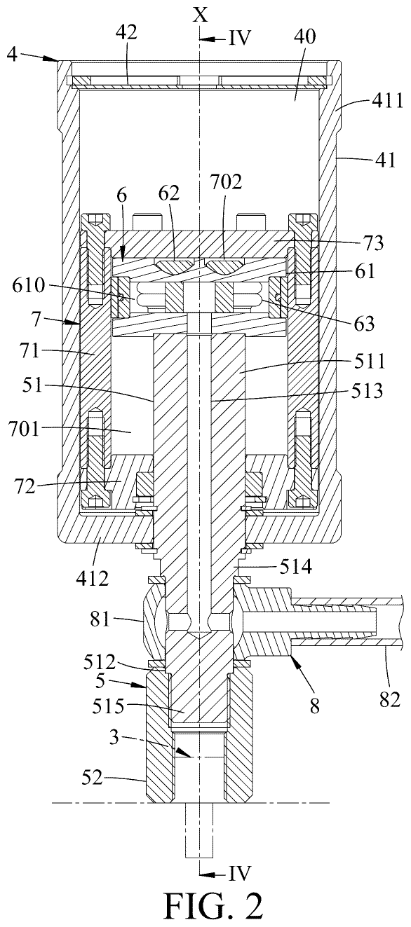

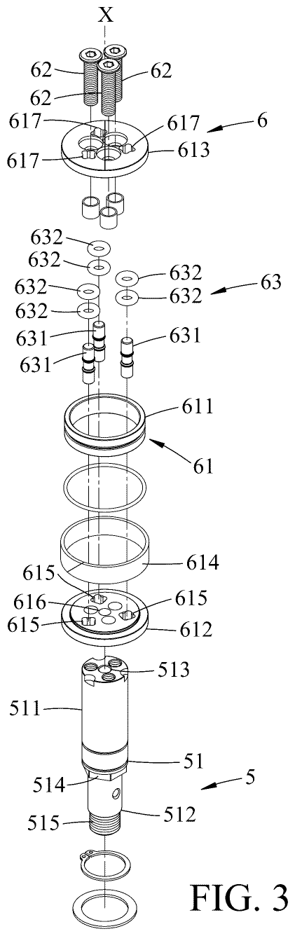

Referring to FIGS. 2, 3 and 4, a first embodiment of a pneumatic puller according to the disclosure is adapted for pulling an object 3 that is fixed at a fixed point. The object 3 may be, for example, a nail, a pin, or a fuel injector nozzle of an engine. The pneumatic puller includes a shell unit 4, a pulling unit 5, a valve unit 6, a cylinder 7, and a tube unit 8.

The shell unit 4 includes a housing 41, and an end cap 42 that is connected to the housing 41 and that cooperates with the housing 41 to define a sliding space 40. The housing 41 surrounds an axis (X), and has an opening portion 411 and a blind end portion 412 that is opposite to the opening portion 411. The blind end portion 412 has a plurality of gas discharge holes 413 that are in spatial communication with the sliding space 40 and an external environment. The end cap 42 is connected to the opening portion 411, and is spaced apart from the blind end portion 412 along the axis (X). The end cap 42 has a plurality of gas discharge holes 421 that are in spatial communication with the sliding space 40 and the external environment.

The pulling unit 5 includes a pulling member 51 that extends in an extending direction of the axis (X), and a pulling sleeve 52. The pulling member 51 is fixedly connected to the blind end portion 412 of the housing 41, and has a fixed section 511 that extends in the sliding space 40, an exposed section 512 that is opposite to the fixed section 511 and that extends out of the shell unit 4, and an intake passage 513 that extends from the exposed section 512 to the fixed section 511 and that is adapted for being in spatial communication with a gas source (not shown). The exposed section 512 has an abutment portion 514 that has a polygonal contour perpendicular to the axis (X) and that is proximate to the housing 41, and a thread portion 515 that is distal from the housing 41. The pulling sleeve 52 threadedly engages the thread portion 515 of the exposed section 512, and is adapted to be sleeved on the object 3.

The valve unit 6 includes a piston 61 that is fixedly connected to the fixed section 511, three fasteners 62, and a directional valve assembly 63 that is movably mounted to the piston 61 and that is adapted for controlling a gas flow direction.

The piston 61 includes an annular seat 611 that surrounds the axis (X), a first end portion 612 that interconnects one end of the annular seat 611 and the fixed section 511 of the pulling member 51, a second end portion 613 that is connected to another end of the annular seat 611 and that is opposite to the first end portion 612, and a washer 614 that is sleeved on an outer surface of the annular seat 611. The annular seat 611, the first end portion 612, and the second end portion 613 cooperatively define a gas chamber 610. The first end portion 612 has three first valve holes 615 that are in spatial communication with the gas chamber 610, and an gas inlet 616 that is located among the first valve holes 615 and that is in spatial communication with the intake passage 513 and the gas chamber 610 (i.e., the gas chamber 610 is in spatial communication with the intake passage 513). The second end portion 613 is spaced apart from the first end portion 612 along the axis (X), and has three second valve holes 617 that are in spatial communication with the gas chamber 610.

The fasteners 62 extend through the second end portion 613 and the first end portion 612, and are connected to the fixed section 511 of the pulling member 51 so that the piston 61 may be fixedly connected to the pulling member 51.

The directional valve assembly 63 includes three directional valve rods 631 and six airtight members 632. Each of the directional valve rods 631 movably extends into a respective one of the first valve holes 615 and a respective one of the second valve holes 617. A length of each of the directional valve rods 631 in the extending direction of the axis (X) is greater than a length of the piston 61 in the extending direction of the axis (X). The airtight members 632 are divided into three groups each of which includes two of the airtight members 632, is sleeved on a respective one of the directional valve rods 631, and is located between the first and second end portions 612, 613.

The cylinder 7 is movably disposed in the sliding space 40, is sleeved on the fixed section 511, and includes a cylinder wall 71 that surrounds the piston 61 and that is in airtight contact with the washer 614 of the piston 61, a first cylinder cover 72, and a second cylinder cover 73. The first end portion 612 of the piston 61 faces the first cylinder cover 72. The second end portion 613 of the piston 61 faces the second cylinder cover 73. The first cylinder cover 72 is connected to the cylinder wall 71 and the pulling member 51, and cooperates with the cylinder wall 71 and the first end portion 612 to define a first chamber 701 that is in spatial communication with the first valve holes 615. The second cylinder cover 73 is connected to the cylinder wall 71, and cooperates with the cylinder wall 71 and the second end portion 613 to define a second chamber 702 that is in spatial communication with the second valve holes 617. The first cylinder cover 72 has a plurality of gas outlets 721 that are in spatial communication with the sliding space 40 and the first chamber 701. The second cylinder cover 73 is spaced apart from the first cylinder cover 72 along the axis (X), and has a plurality of gas outlets 731 that are in spatial communication with the sliding space 40 and the second chamber 702.

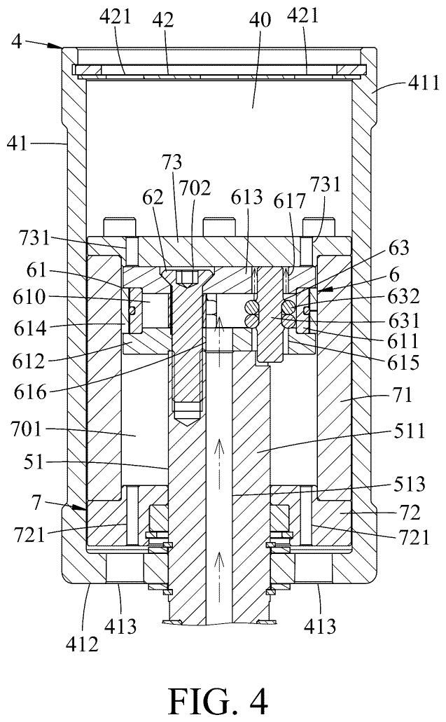

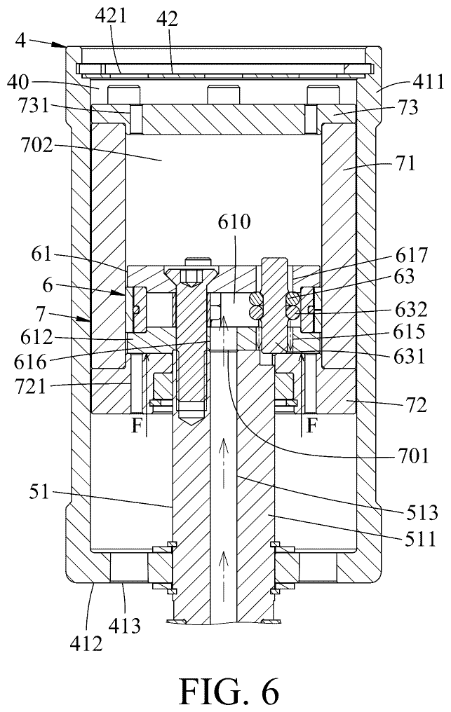

The cylinder 7 is movable along the fixed section 511 between a first reverse position (see FIG. 4) and a second reverse position (see FIG. 6) relative to the piston 61 when urged by pressure of a gas. Referring to FIG. 4, when the cylinder 7 is in the first reverse position, the first cylinder cover 72 of the cylinder 7 is adjacent to the blind end portion 412 of the housing 41 and is spaced apart from the end cap 42, and the second cylinder cover 73 abuts against the second end portion 613 of the piston 61. At this time, the airtight members 632 of the directional valve assembly 63 block the spatial communication between the gas chamber 610 and each of the first valve holes 615, and allow the spatial communication between the gas chamber 610 and each of the second valve holes 617 such that the gas chamber 610 is in spatial communication with the second chamber 702.

Referring to FIG. 6, when the cylinder 7 is in the second reverse position, the second cylinder cover 73 of the cylinder 7 is adjacent to the end cap 42 and is spaced apart from the blind end portion 412, and the first cylinder cover 72 abuts against the first end portion 612 of the piston 61. At this time, the airtight members 632 of the directional valve assembly 63 block the spatial communication between the gas chamber 610 and each of the second valve holes 617, and allow the spatial communication between the gas chamber 610 and each of the first valve holes 615 such that the gas chamber 610 is in spatial communication with the first chamber 701.

The directional valve rods 631 respectively extend out of the first valve holes 615 when the cylinder 7 is in the first reverse position. The directional valve rods 631 respectively extend out of the second valve holes 617 when the cylinder 7 is in the second reverse position.

Referring to FIGS. 6, 7, and 4, when the cylinder 7 is moved from the second reverse position to the first reverse position, the cylinder 7 is moved along the fixed section 511 toward the blind end portion 412, and the directional valve rods 631 that respectively extend out of the second valve holes 617 are pushed by the second cylinder cover 73 to move relative to the piston 61 toward the first cylinder cover 72 such that the directional valve rods 631 respectively extend out of the first valve holes 615.

Referring to FIGS. 4, 5, and 6, when the cylinder 7 is moved from the first reverse position to the second reverse position, the cylinder 7 is moved along the fixed section 511 toward the end cap 42, and the directional valve rods 631 that respectively extend out of the first valve holes 615 are pushed by the first cylinder cover 72 to move relative to the piston 61 toward the second cylinder cover 73 such that the directional valve rods 631 respectively extend out of the second valve holes 617.

The tube unit 8 includes a connector 81 that is sleeved on the exposed section 512 and that is in spatial communication with the intake passage 513, and a hose 82 that interconnects the connector 81 and the gas source. The connector 81 is located between and abuts against the pulling sleeve 52 and the abutment portion 514 of the pulling member 51. As a length of the thread engagement between the pulling sleeve 52 and the thread portion 515 becomes longer, the connector 81 is more tightly secured to the exposed section 512.

Referring to FIGS. 2, and 4 to 7, when a user wants to remove the object 3 from the fixed point, the user may sleeve the pulling sleeve 52 on the object 3, and the gas provided by the gas source is guided through the tube unit 8 to the intake passage 513. As such, the cylinder 7 is urged by the pressure of the gas to move in the sliding space 40. An operation of the cylinder 7 of the first embodiment of the pneumatic puller will be described below.

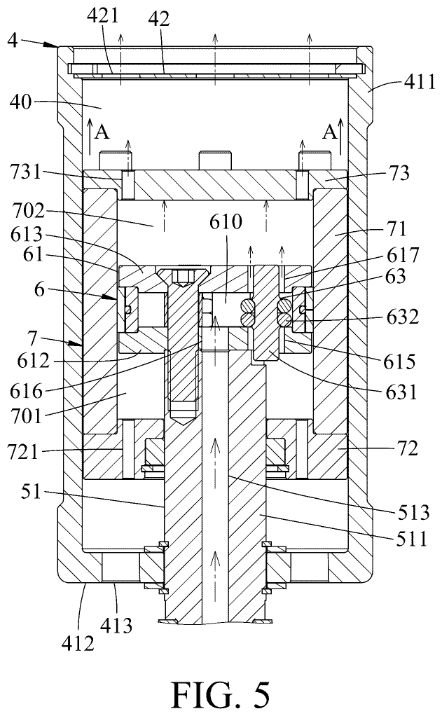

Referring to FIGS. 4, 5, and 6, when the gas flows from the intake passage 513 into the second chamber 702 through the gas inlet 616, the gas chamber 610, and the second valve holes 617 (i.e., the directional valve assembly 63 releases the gas into the second chamber 702 when the cylinder 7 is in the first reverse position), as shown by phantom line arrows, the gas exerts the pressure on the second cylinder cover 73 and the second end portion 613. Through such operation, because the piston 61 and the fixed section 511 are stationary relative to the housing 41, the cylinder 7 is urged by the pressure of the gas to move along the fixed section 511 away from the exposed section 512, as shown by solid line arrows (A) in FIG. 5.

At this time, the cylinder 7 is moved from the first reverse position toward the second reverse position such that a volume of the second chamber 702 is gradually expanded and that a volume of the first chamber 701 is gradually decreased. When the first cylinder cover 72 approaches the first end portion 612 of the piston 61, the directional valve rods 631 are pushed by the first cylinder cover 72 to move toward the second cylinder cover 73. When the cylinder 7 is moved to the second reverse position, the cylinder 7 hits the piston 61, and the airtight members 632 of the directional valve assembly 63 block the spatial communication between the gas chamber 610 and each of the second valve holes 617, and allow the spatial communication between the gas chamber 610 and each of the first valve holes 615 such that the gas chamber 610 is in spatial communication with the first chamber 701 (i.e., the directional valve assembly 63 allows the gas that is contained in the gas chamber 610 to flow into the first chamber 701). It is noted that, when an amount of the gas in the second chamber 702 gradually reaches a gas capacity of the second chamber 702, the gas may enter the sliding space 40 through the gas outlet 731 of the second cylinder cover 73 (the gas outlets 731 guide the gas that is in the second chamber 702 to the sliding space 40), and the gas discharge holes 421 of the end cap 42 guide the gas that is in the sliding space 40 to the external environment such that the gas is discharged.

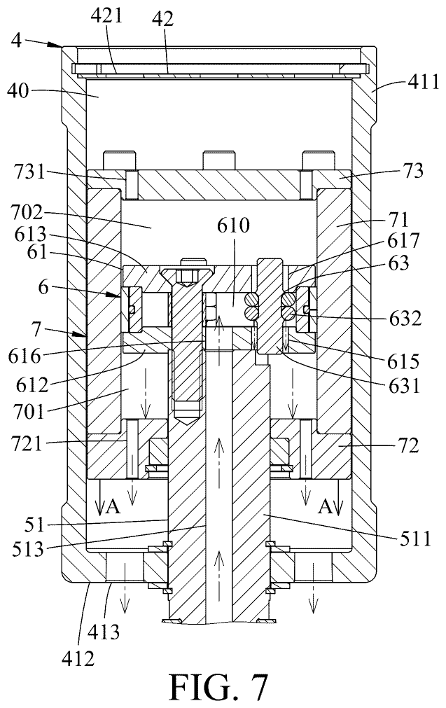

Referring to FIGS. 6, 7, and 4, when the gas flows from the intake passage 513 into the first chamber 701 through the gas inlet 616, the gas chamber 610, and the first valve holes 615 (i.e., the directional valve assembly 63 releases the gas into the first chamber 701 when the cylinder 7 is in the second reverse position), as shown by the phantom line arrows, the gas exerts the pressure on the first cylinder cover 72 and the first end portion 612. Through such operation, because the piston 61 and the fixed section 511 are stationary relative to the housing 41, the cylinder 7 is urged by the pressure of the gas to move along the fixed section 511 toward the exposed section 512, as shown by solid line arrows (A) in FIG. 7.

At this time, the cylinder 7 is moved from the second reverse position toward the first reverse position such that the volume of the first chamber 701 is gradually expanded and that the volume of the second chamber 702 is gradually decreased. When the second cylinder cover 73 approaches the second end portion 613 of the piston 61, the directional valve rods 631 are pushed by the second cylinder cover 73 to move toward the first cylinder cover 72. When the cylinder 7 is moved to the first reverse position, the cylinder 7 abuts against the piston 61, and the airtight members 632 of the directional valve assembly 63 block the spatial communication between the gas chamber 610 and each of the first valve holes 615, and allow the spatial communication between the gas chamber 610 and each of the second valve holes 617 such that the gas chamber 610 is in spatial communication with the second chamber 702 (i.e., the directional valve assembly 63 allows the gas that is contained in the gas chamber 610 to flow into the second chamber 702). It is noted that, when an amount of the gas in the first chamber 701 gradually reaches a gas capacity of the first chamber 701, the gas may enter the sliding space 40 through the gas outlet 721 of the first cylinder cover 72 (the gas outlets 721 guide the gas that is in the first chamber 701 to the sliding space 40), and the gas discharge holes 413 of the blind end portion 412 guide the gas that is in the sliding space 40 to the external environment such that the gas is discharged.

Then, when operations shown in FIGS. 4 to 7 are repeated, the cylinder 7 serves as a heavy hammer that continuously hits the piston 61 during reciprocating motion of the cylinder 7 relative to the piston 61. Through such operation, as shown in FIG. 6, the piston 61 bears an impact force (F), and urges the pulling member 51 and the pulling sleeve 52 to move in a direction of the impact force (F). During movement of the pulling member 51, the pulling sleeve 52 pulls the object 3 in the direction of the impact force (F) until the object 3 is separated from the fixed point, thereby achieving the purpose of removing the object 3.

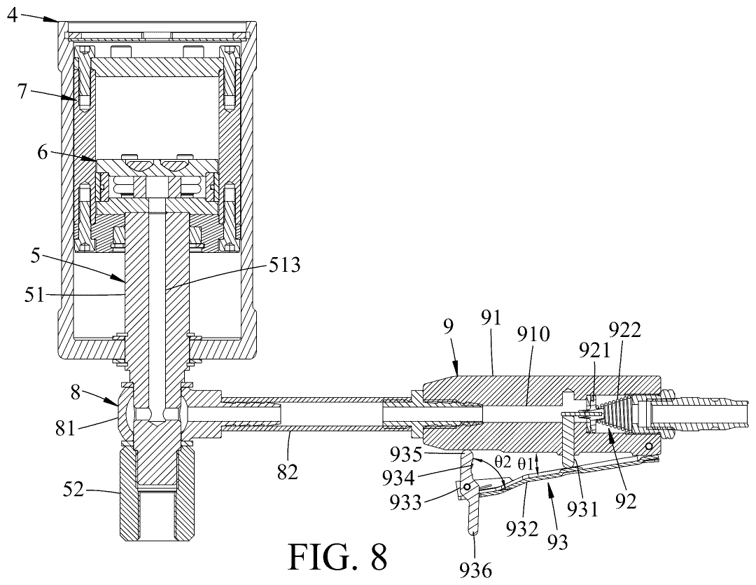

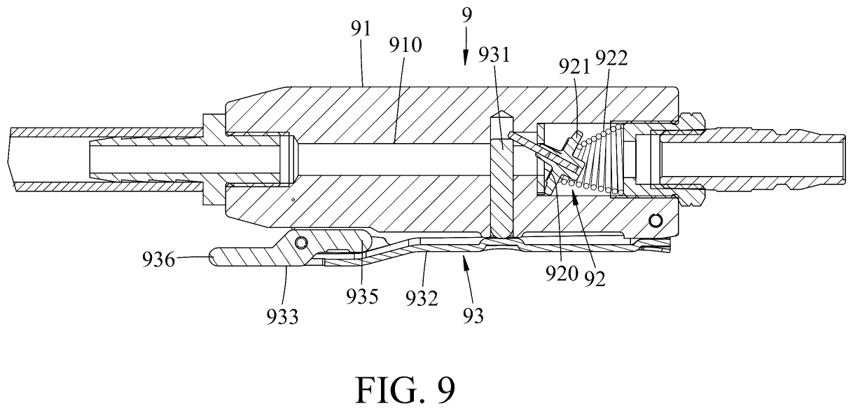

Referring to FIGS. 8 and 9, a second embodiment of the pneumatic puller according to the disclosure is similar to the first embodiment except that, in the second embodiment, the pneumatic puller further includes a control unit 9.

The control unit 9 includes a valve seat 91, an intake valve assembly 92 that is mounted to the valve seat 91, and a trigger subunit 93 that is mounted to the valve seat 91 and that is operable.

The valve seat 91 is connected to the exposed section 512, and has a channel 910 that is in spatial communication with the intake passage 513 and the gas source, and that is adapted for guiding the gas into the intake passage 513. Specifically, the valve seat 91 is connected to the hose 82 and the gas source, and the tube unit 8 interconnects the exposed section 512 of the pulling member 51 and the valve seat 91 for guiding the gas from the valve seat 91 into the intake passage 513.

The intake valve assembly 92 openably closes the channel 910, and includes a gas valve 921 that abuts against the valve seat 91 to close the channel 910, and a first resilient member 922 that abuts against the valve seat 91 and the gas valve 921. The gas valve 921 cooperates with the valve seat 91 to define an opening 920 that is in spatial communication with the channel 910 when the intake valve assembly 92 opens the channel 910. The first resilient member 922 resiliently biases the gas valve 921 toward the valve seat 91.

The trigger unit 93 is operable to urge the intake valve assembly 92 to open the channel 910, and includes a switch valve rod 931 that extends through the valve seat 91 and that is movable relative to the gas valve 921, a trigger 932 that is pivotably connected to the valve seat 91 and that is operable to urge the switch valve rod 931 to move, a safety member 933 that is rotatably connected to the trigger 932, and a second resilient member 934 that abuts against the trigger 932 and the safety member 933. The switch valve rod 931 is operable to urge the gas valve 921 to move relative to the valve seat 91, and is operable to control a dimension of the opening 920. The trigger 932 and the valve seat 91 cooperatively define a first angle (01) therebetween that is variable. A numerical value of the first angle (01) and a numerical value of the dimension of the opening 920 have a negative relationship. The safety member 933 is rotatably connected to the trigger 932, and has an abutment section 935 and a pushed section 936 that is opposite to the abutment section 935. The abutment section 935 and the trigger 932 cooperatively define a second angle (02) therebetween that is variable. The pushed section 936 is operable to urge the abutment section 935 to move so that a numerical value of the second angle (02) may change. The second resilient member 934 resiliently biases the abutment section 935 away from the trigger 932 such that the numerical value of the second angle (02) is maximized and that one end of the trigger 932 is kept away from the valve seat 91.

When the safety member 933 is biased by the second resilient member 934 and when the numerical value of the second angle (02) is maximized, the abutment section 935 keeps the one end of the trigger 932 away from the valve seat 91 such that movement of the trigger 932 is blocked by the safety member 933 and that the trigger 932 is not operable. As such, the trigger 932 is prevented from being accidentally pressed.

When the pushed section 936 of the safety member 933 is operated to urge the abutment section 935 to move toward the trigger 932, the numerical value of the second angle (02) is reduced until the abutment section 935 and the trigger 932 overlap. When the abutment section 935 and the trigger 932 overlap, the trigger 932 is operable to approach the valve seat 91 such that the numerical value of the first angle (01) is reduced. During a process of reducing the numerical value of the first angle (01), the switch valve rod 931 is pushed by the trigger 932 to push the gas valve 921 such that the numerical value of the dimension of the opening 920 is increased (i.e., the opening 920 is expanded). As such, the gas is controlled to flow through the opening 920 into the channel 910, the intake passage 513, and the cylinder 7. In addition, an amount of the gas that flows into the cylinder 7 is adjustable by controlling the numerical value of the first angle (01), thereby adjusting magnitude of the impact force (F).

Through the above description, the advantages of the pneumatic puller are summarized as follows.

1. The impact force (F) is generated by the pressure of the gas, which is labor-saving and time-saving, and the pneumatic puller may remove the object 3 quickly.

2. It is important that the cylinder 7, which is relatively heavy, serves as a movable element in the pneumatic puller so that the magnitude of the impact force (F) may be greater. Moreover, the cylinder 7 is concealed in the shell unit 4, and is not in contact with its surroundings when in operation, thereby enhancing product safety when the pneumatic puller is in use.

3. In addition, by virtue of the control unit 9 controlling the amount of the gas that flows into the cylinder 7, the magnitude of the impact force (F) is adjusted.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A pneumatic puller comprising:
a shell unit defining a sliding space;
a pulling member fixedly connected to the shell unit, and having a fixed section that extends in the sliding space and an exposed section that is opposite to the fixed section;
a valve unit including a piston that is fixedly connected to the fixed section, and a directional valve assembly that is movably mounted to the piston and that is adapted for controlling a gas flow direction; and
a cylinder movably disposed in the sliding space, sleeved on the fixed section, and including a cylinder wall that surrounds the piston and that is in airtight contact with the piston, the cylinder and the piston defining a first chamber and a second chamber, the cylinder being movable along the fixed section between a first reverse position and a second reverse position relative to the piston when urged by pressure of a gas, the cylinder abutting against one side of the piston and the directional valve assembly releasing the gas into the second chamber when the cylinder is in the first reverse position, the cylinder abutting against another side of the piston and the directional valve assembly releasing the gas into the first chamber when the cylinder is in the second reverse position, the cylinder moving along the fixed section away from the exposed section and hitting the piston when moving from the first reverse position to the second reverse position.

2. The pneumatic puller as claimed in claim 1, wherein the shell unit includes a housing, and an end cap that is connected to the housing and that cooperates with the housing to define the sliding space, the housing surrounding an axis, and having an opening portion and a blind end portion that is opposite to the opening portion, the end cap being connected to the opening portion and being spaced apart from the blind end portion along the axis, the cylinder being adjacent to the blind end portion and being spaced apart from the end cap when the cylinder is in the first reverse position.

3. The pneumatic puller as claimed in claim 2, wherein, when the cylinder is in the second reverse position, the cylinder is adjacent to the end cap and is spaced apart from the blind end portion.

4. The pneumatic puller as claimed in claim 2, wherein the blind end portion of the shell unit has a plurality of gas discharge holes that are in spatial communication with the sliding space and an external environment, the end cap having a plurality of gas discharge holes that are in spatial communication with the sliding space and the external environment, the gas discharge holes of the blind end portion and the gas discharge holes of the end cap being adapted for guiding the gas that is in the sliding space to the external environment, the cylinder further including a first cylinder cover that is connected to the cylinder wall and the pulling member, and a second cylinder cover that is connected to the cylinder wall and that is spaced apart from the first cylinder cover along the axis, the first cylinder cover having a plurality of gas outlets that are in spatial communication with the first chamber and the sliding space, the second cylinder cover having a plurality of gas outlets that are in spatial communication with the second chamber and the sliding space, the gas outlets of the first cylinder cover and the gas outlets of the second cylinder cover being adapted for guiding the gas that is in the cylinder to the sliding space.

5. The pneumatic puller as claimed in claim 4, wherein the pulling member further has an intake passage that extends from the exposed section to the fixed section and that is adapted for being in spatial communication with a gas source, the piston defining a gas chamber that is in spatial communication with the intake passage, the directional valve assembly being adapted for allowing the gas that is contained in the gas chamber to flow into the cylinder.

6. The pneumatic puller as claimed in claim 5, wherein:
the piston includes a first end portion that faces the first cylinder cover, and a second end portion that is opposite to the first end portion and that faces the second cylinder cover, the first end portion having a plurality of first valve holes that are in spatial communication with the gas chamber and the first chamber, the second end portion having a plurality of second valve holes that are in spatial communication with the gas chamber and the second chamber, the directional valve assembly including a plurality of directional valve rods each of which movably extends into a respective one of the first valve holes and a respective one of the second valve holes, and a plurality of airtight members that are sleeved on the directional valve rods;
when the cylinder is in the first reverse position, the first cylinder cover is adjacent to the blind end portion of the housing, the second cylinder cover is in contact with the second end portion of the piston, and the airtight members block the spatial communication between the gas chamber and each of the first valve holes; and
when the cylinder is in the second reverse position, the first cylinder cover is in contact with the piston, the second cylinder cover is adjacent to the end cap, and the airtight members block the spatial communication between the gas chamber and each of the second valve holes.

7. The pneumatic puller as claimed in claim 6, wherein:
a length of each of the directional valve rods in an extending direction of the axis is greater than a length of the piston in the extending direction of the axis, the directional valve rods respectively extending out of the first valve holes when the cylinder is in the first reverse position, the directional valve rods respectively extending out of the second valve holes when the cylinder is in the second reverse position;
when the cylinder is moved from the first reverse position to the second reverse position, the directional valve rods that respectively extend out of the first valve holes are pushed by the first cylinder cover to move relative to the piston such that the directional valve rods respectively extend out of the second valve holes; and
when the cylinder is moved from the second reverse position to the first reverse position, the directional valve rods that respectively extend out of the second valve holes are pushed by the second cylinder cover to move relative to the piston such that the directional valve rods respectively extend out of the first valve holes.

8. The pneumatic puller as claimed in claim 5, further comprising a control unit that includes a valve seat that is connected to the exposed section, an intake valve assembly that is mounted to the valve seat, and a trigger subunit that is mounted to the valve seat and that is operable, the valve seat having a channel that is in spatial communication with the intake passage and the gas source, and that is adapted for guiding the gas into the intake passage, the intake valve assembly openably closing the channel, the trigger subunit being operable to urge the intake valve assembly to open the channel.

9. The pneumatic puller as claimed in claim 8, wherein the intake valve assembly includes a gas valve that abuts against the valve seat to close the channel, and a first resilient member that abuts against the valve seat and the gas valve, the gas valve cooperating with the valve seat to define an opening that is in spatial communication with the channel when the intake valve assembly opens the channel, the first resilient member resiliently biasing the gas valve toward the valve seat, the trigger subunit including a switch valve rod that extends through the valve seat and that is movable relative to the gas valve, and a trigger that is pivotably connected to the valve seat and that is operable to urge the switch valve rod to move, the switch valve rod being operable to urge the gas valve to move relative to the valve seat and being operable to control a dimension of the opening, the trigger and the valve seat cooperatively defining a first angle therebetween that is variable, a numerical value of the first angle and a numerical value of the dimension of the opening having a negative relationship.

10. The pneumatic puller as claimed in claim 9, wherein the trigger subunit further includes a safety member and a second resilient member, the safety member being rotatably connected to the trigger, and having an abutment section and a pushed section that is opposite to the abutment section, the abutment section and the trigger cooperatively defining a second angle therebetween that is variable, the pushed section being operable to urge the abutment section to move so that a numerical value of the second angle is reduced, the second resilient member abutting against the trigger and the safety member, and resiliently biasing the abutment section away from the trigger such that the numerical value of the second angle is maximized and that one end of the trigger is kept away from the valve seat.

11. The pneumatic puller as claimed in claim 8, further comprising a tube unit that interconnects the exposed section of the pulling member and the valve seat for guiding the gas from the valve seat into the intake passage.

12. The pneumatic puller as claimed in claim 11, wherein the tube unit includes a connector that is sleeved on the exposed section and that is in spatial communication with the intake passage, and a hose that interconnects the connector and the valve seat.
